(19) United States
(12) Patent Application Publication
(10) Pub. No.: US 2020/0229651 A1
(43) Pub. Date: Jul. 23, 2020

(54) Compact Vegetable and Fruit Washer

(71) Applicant: Mary Ellen Hoye, Homer Glen, IL (US)

(72) Inventor: Mary Ellen Hoye, Homer Glen, IL (US)

(21) Appl. No.: 16/252,921

(22) Filed: Jan. 21, 2019

(51) Int. Cl. A47J 43/24

(52) U.S. Cl. CPC A47J 43/24

(57) ABSTRACT

A two-part, fold-up vegetable and fruit washing device with a removable lid. The bottom and lid take the form of a standard plastic, or other material, lidded container. The middle part is a pop-out strainer that holds the vegetable or fruit being washed or rinsed. The strainer in the middle part can pop out to strain, or can pop into a folded, flat configuration for storage. In the folded configuration, the middle part is placed in the bottom part, and the lid is put in place. The folded device takes up no more room than a normal plastic lidded container typically found in kitchens.

### BACKGROUND

### Field of the Invention

The present invention is generally related to fruit and vegetable cleaners and more particularly to a fold-up, portable vegetable and fruit washing device.

### Description of the Prior Art

The importance of through washing of vegetables and fruit is well-known. One only needs to note the recent outbreaks of food-borne diseases. Vegetables, especially vegetables that grow near the ground, are particularly subject to contamination from animal wastes and other contaminants. For example, recently there has been a major outbreak of e-coli related illness from types of lettuce. Both fruits and vegetables, but especially fruits, are subject to numerous sprayings of insecticides as well as liquid fertilizers.

Prior art washers have typically been large, bulky machines suited for restaurants and food outlets. Their use in the home is generally prohibited by size and cost. There have been other portable fruit and vegetable washers such as the one described in my U.S. Pat. No. ______. However, even this device is somewhat bulky and is equipped with valves. It would be very advantageous to have a fold-up vegetable and fruit washer that is made typically from plastic that can be sold economically for use in the home.

### SUMMARY OF THE INVENTION

The present invention relates to a two-part, fold-up vegetable and fruit washing device. The device also has a removable lid. The bottom and lid take the form of a standard plastic, or other material, lidded container. The middle part is a pop-out strainer that holds the vegetable or fruit being washed or rinsed. The strainer in the middle part can pop out to strain, or can pop in to a folded, flat configuration for storage. In the folded configuration, the middle part is placed in the bottom part, and the lid is put in place. The folded device takes up no more room than a normal plastic lidded container typically found in kitchens.

In the wash configuration, the middle part is popped out to form a strainer and food well that holds the vegetable or fruit being washed. Washing fluid, which can be pure filtered water, bottled water, or water mixed with a cleaning solution that acts as a surfactant, is placed in the bottom portion. The middle portion is popped out, and the vegetable or fruit is placed on the strainer. The lid is put in place, and the device can be agitated vigorously by hand to completely clean the food. Pieces of dirt and contamination pass through the strainer and end up in the bottom of the bottom portion. The lid can be removed, and the middle part can be removed while the bottom part is emptied. The process can be repeated with pure water alone to completely rinse the food. Finally, the clean vegetable or fruit can be removed by taking out the middle part.

The device is dish-washer friendly being washable as three separate pieces. Finally, the middle part can be popped into the folded configuration, placed in the bottom part, and with the lid in place, the device is ready for storage or transport in a lunch bag, backpack or the like.

### DESCRIPTION OF THE FIGURES

Attention is now directed to several figures that illustrate features of the present invention.

FIG. 1 shows an embodiment of the present invention in the folded, storage configuration.

FIG. 2 shows the embodiment of FIG. 1 in the lid-off, popped out configuration.

FIG. 3 is a top-down view of the configuration of FIG. 2. The strainer can be clearly seen extending into the bottom part of the device.

FIG. 4. is to-down view of the middle part with the strainer popped up in the folded configuration.

FIG. 5 is a bottom-up view of the middle part with the strainer popped up in the folded configuration being approximately parallel with the top.

FIG. 6 is a bottom-up view of the middle part with the strainer popped into the unfolded configuration ready to receive food to be washed.

Several illustrations have been presented to aid in understanding the present invention. The scope of the present invention is not limited to what is shown in the figures.

### DESCRIPTION OF THE PREFERRED EMBODIMENTS

The present invention relates to a fold-up, portable home vegetable and fruit washing device that includes three parts: a lid, a middle strainer section, and a bottom bowl section. The middle section or part has a strainer that pops out into a use configuration and pops in to a flat, folded configuration. With the middle part in the folded configuration, the device fits tightly together for storage or transport. With the middle part in the unfolded or popped-out configuration, the device is ready to use to wash food products like vegetables and fruits.

The present invention eliminates the need for a colander when washing fruits and vegetables. One can go from dirty vegetables to ready to serve or store in the refrigerator. The strainer can be flush with the lid to strain, extended to strain and further rinse or be depressed into the bowl to serve and hold fruit away from the water and allow it to further dry. The strainer can be attached to the lid or removable. The size of the device can be large enough for multiple servings or single serving. The plastic or other material of the device should be BPA free. The container is completely liquid sealed because the user shakes the container depending on the fruit or vegetable that is put into it. This shaking creates an ultrasonic effect which vibrates off additional residue and particles of debris.

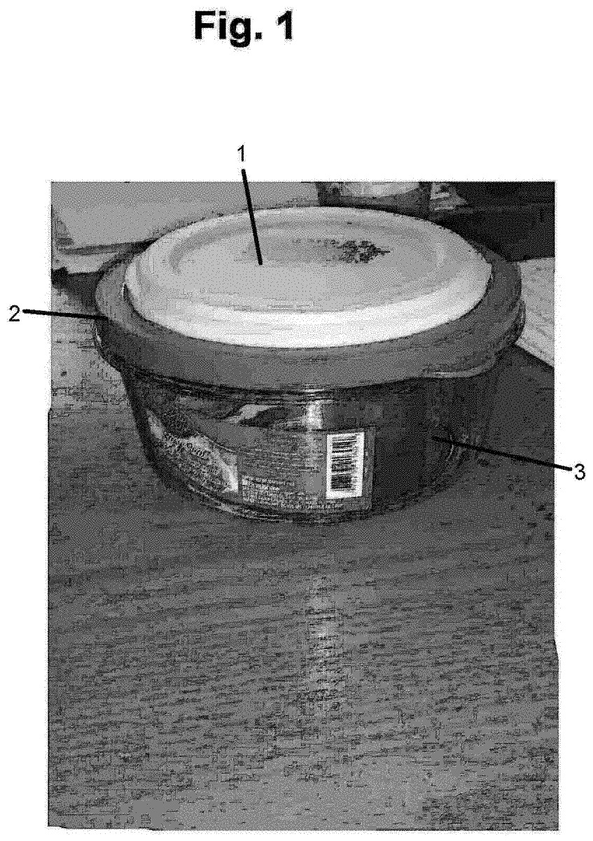

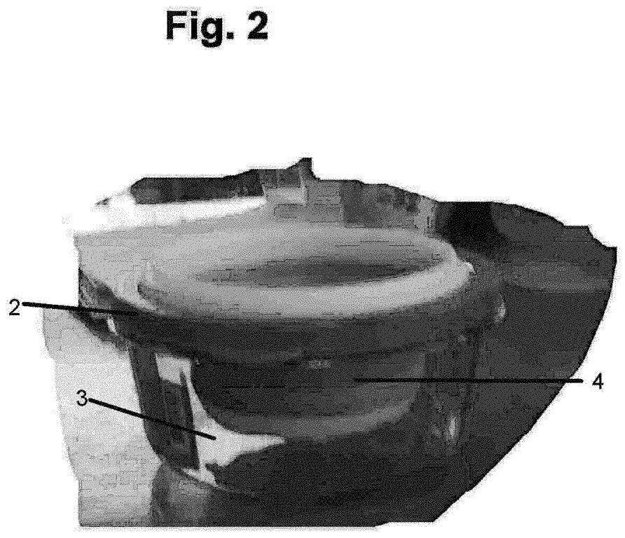

FIG. 1 shows the entire device in the folded configuration for storage. The top 1, middle 2 and bottom 3 sections fit tightly together. In the configuration of FIG. 1, the device stores or can be transported just as any common kitchen container. FIG. 2 shows the embodiment of FIG. 1 with the lid 1 removed, and the strainer part 4 of the middle section 2 popped out or extended. The strainer part 4 can be seen through the clear plastic of the bottom section 3. It should be noted that the bottom or bowl section 3 need not be transparent, but can be any strong, flexible material. Vegetables or fruit are inserted into the popped out strainer part 4, and the lid is put back in place after placing water or cleaning compound in the bottom section 3.

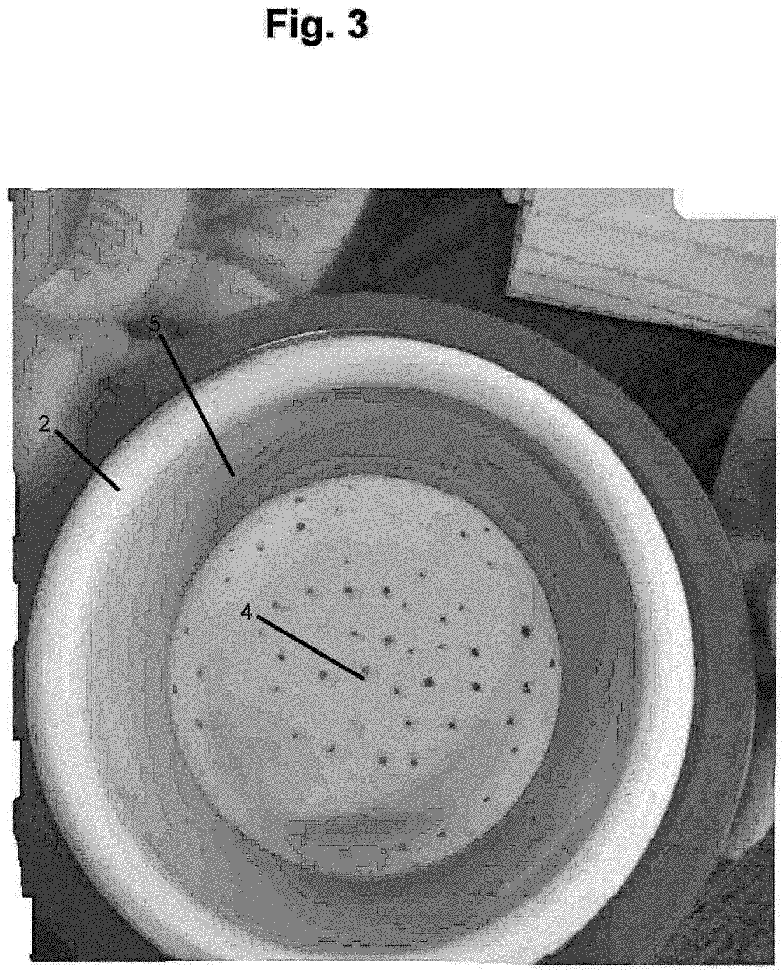

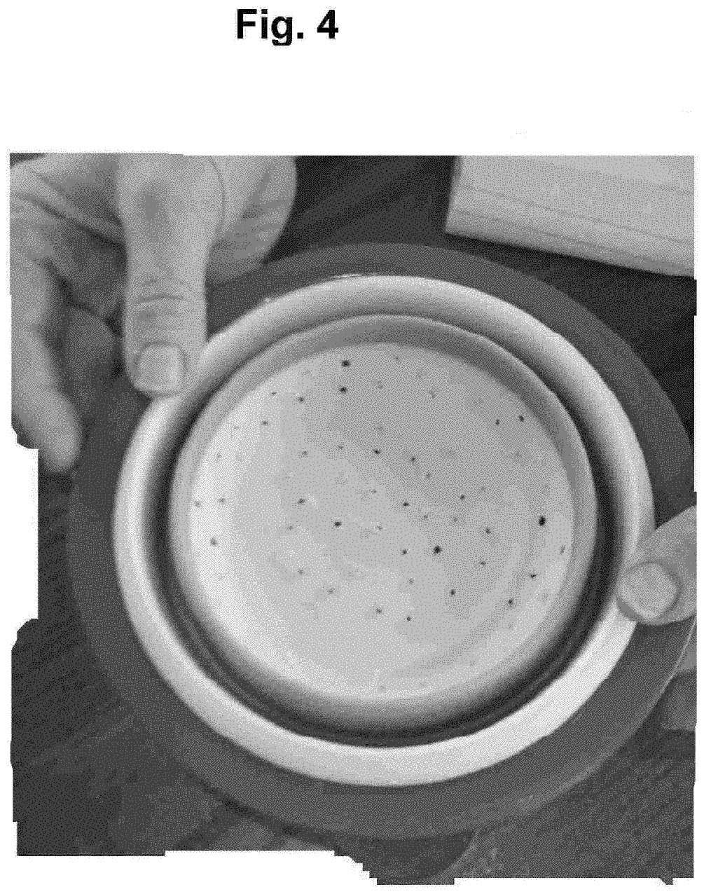

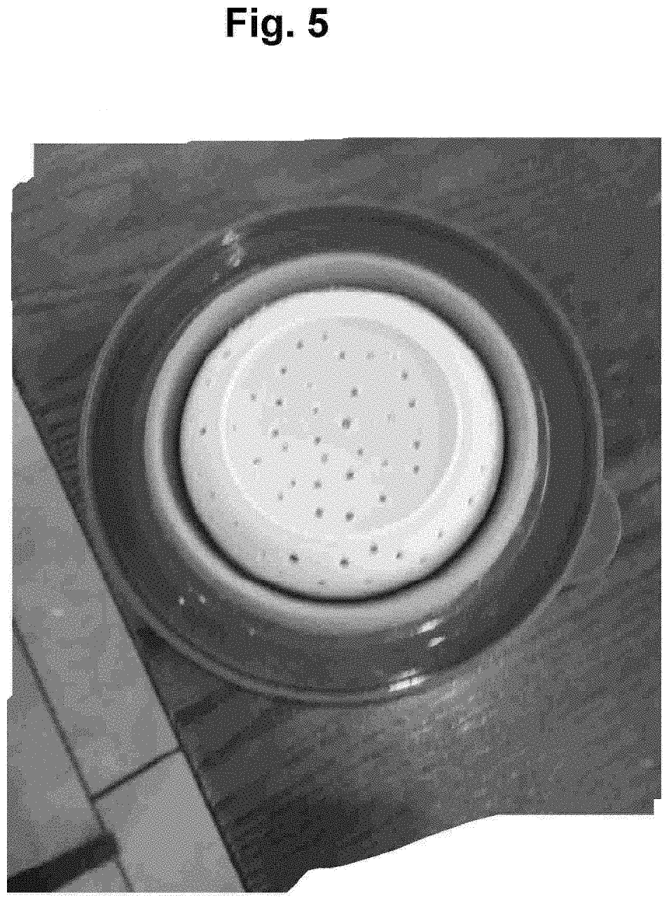

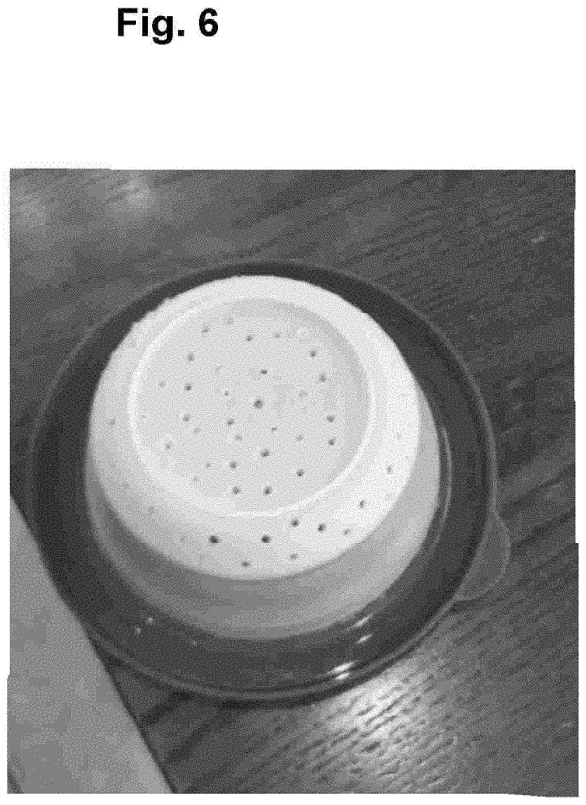

FIG. 3 is a top-down view of the device in FIG. 2. It shows the strainer part 4 ready to receive food with the middle section 2 inserted into the bottom section 3. It also shows the rubber hinge 5 holding the strainer 4 and connected to the middle section 2. FIG. 4 is a top-down view of the middle section with the strainer popped up in the folded configuration. FIG. 5 is a bottom-up view of the folded configuration of FIG. 4. FIG. 6 is a bottom up view of the middle section with the strainer popped down in the use configuration ready to receive food to be washed.

The middle section of the device includes a ring made of an elastic material such as rubber with the strainer being made of a rigid material such as rigid plastic. The rigid strainer can have numerous penetrating holes, large enough to pass dirt, liquid and contaminates, but small enough to prevent any of the food being washed from passing through. The strainer uses the elastic ring as a hinge as it pops in or out. The ring is attached so that it forms a curve or arch along its cross section to achieve the hinge effect.

The lid and bowl can be made of plastic, and can be transparent or opaque. The plastic can be flexible, but should be rigid enough to hold the shape of the container.

As previously stated, the strainer 4 can be flush with the lid 1 to strain, extended to strain and further rinse, or be depressed into the bowl 3 to serve and hold fruit away from the water and allow it to further dry. The strainer 4 can be attached to the lid 1 or removable.

Several descriptions and illustrations have been presented to aid in understanding the present invention. One with skill in the art will realize that numerous changes and variations are possible without departing from the spirit of the invention. Each of these changes and variations is within the scope of the present invention.

I claim:

1. A food washing device comprising:
a lower bowl section;
a middle strainer section;
a lid;
wherein the middle strainer section fits into the bowl section, and the lid fits on the bowl section with the middle strainer section installed;
wherein, the middle strainer section comprises an outer ring with an attached inner strainer, the inner strainer having a plurality of holes; and
wherein, the middle strainer section has a folded configuration with the inner strainer at a level approximately that of the ring, and an unfolded configuration with the inner strainer popped down to a level below that of the ring;
wherein, the device in the unfolded configuration with the bowl section, the middle strainer section and the lid assembled, is liquid tight;
whereby, in the unfolded configuration food may be placed in the inner strainer for washing, serving and storage, and in the folded configuration, the device may be stored.

2. The food washing device of claim 1 wherein the bowl section is plastic.

3. The food washing device of claim 2 wherein the plastic is transparent.

4. The food washing device of claim 1 wherein the lid is plastic.

5. The food washing device of claim 1 wherein the ring is rubber;

6. The food washing device of claim 1 wherein the strainer is rigid plastic.

7. The food washing device of claim 1 wherein the strainer moves from the folded configuration to the unfolded configuration using the ring as a hinge.

8. A three-part, foldable vegetable and fruit washer comprising, in combination a bowl, a lid and a middle section, that fit together to form a liquid tight container, wherein the middle section comprises a rubber ring attached as a hinge to a plastic strainer, the plastic strainer having a plurality of holes large enough to pass dirt and contaminants and small enough to not pass food being washed, wherein, the strainer is configured to pop along the ring from a folded configuration to an unfolded configuration, wherein, in the unfolded configuration, the strainer extends into the bowl.

9. The three-part, foldable vegetable and fruit washer of claim 8 wherein the bowl section is plastic.

10. The three-part, foldable vegetable and fruit washer of claim 9 wherein the plastic is transparent.

11. The three-part, foldable vegetable and fruit washer of claim 8 wherein the lid is plastic.

12. The three-part, foldable vegetable and fruit washer of claim 8 wherein the ring is rubber;

13. The three-part, foldable vegetable and fruit washer of claim 8 wherein the strainer is rigid plastic.

14. A method for providing a food washing device comprising:
providing a lower bowl section;
providing a middle strainer section;
providing a lid; wherein the middle strainer section fits into the bowl section, and the lid fits on the bowl section with the middle strainer section installed;
providing the middle strainer section with an outer ring with an attached inner strainer, the inner strainer having a plurality of holes; wherein, the middle strainer section has a folded configuration with the inner strainer at a level approximately that of the ring, and an unfolded configuration with the inner strainer popped out to a level below that of the ring, wherein the ring acts as a hinge.

15. The method of claim 14 wherein the bowl section is plastic.

16. The method of claim 15 wherein the plastic is transparent.

17. The method of claim 14 wherein the lid is plastic.

18. The method of claim 14 wherein the ring is rubber;

19. The method of claim 14 wherein the strainer is rigid plastic.
